(19) United States
(12) Patent Application Publication
(10) Pub. No.: US 2019/0154058 A1
(43) Pub. Date: May 23, 2019

(54) BLOWER WITH INDENTATIONS

(71) Applicant: BLACK & DECKER INC., New Britain, CT (US)

(72) Inventors: Oleksiy SERGYEYENKO, Baldwin, MD (US); Frank MANNARINO, Baltimore, MD (US); Patrick Joseph TILSON, Parkville, MD (US)

(21) Appl. No.: 16/150,994

(22) Filed: Oct. 3, 2018

Related U.S. Application Data
(60) Provisional application No. 62/589,440, filed on Nov. 21, 2017.

(51) Int. Cl. F04D 29/54; F04D 29/68; F04D 19/00; F04D 29/52

(52) U.S. Cl. CPC F04D 29/547; F04D 29/681; F05D 2210/33; F04D 29/522; F05D 2250/51; F04D 19/002

(57) ABSTRACT

According to examples, a blower may include a housing, a fan positioned within the housing, the fan having a fan edge, and a fan housing section encircling the fan, the fan housing section having an inner surface that spans an inner circumference of the housing section, the inner surface having a plurality of indentations and being spaced within a certain distance from the fan edge.

### FIELD

The present disclosure relates to a blower having a housing and a fan, in which an interior section of the housing around the fan includes a plurality of indentations. The indentations are to increase turbulence around an outer edge of the fan as the fan rotates, which decreases an effective gap between the outer edge of the fan and the interior section of the housing. The decrease in the effective gap size may reduce the back flow of air through the gap, which may improve airflow and/or may increase velocity of the airflow forced through the blower.

### BACKGROUND

Blowers are in common use to remove debris such as leaves and grass clippings through the generation of a fast moving stream of airflow from the blowers. The blowers include impellers to draw air into the blowers through inlets and to force airflow out of the blowers through outlets. The blowers typically include a housing and a blower tube fitted over the outlet of the housing to direct the stream of airflow to a nozzle at the end of the blower tube such that the airflow is forced out of the nozzle at a relatively high speed. The length of the blower tube typically allows a user to stand and hold the blower while positioning the nozzle near the debris to be cleared. In addition, the nozzle outlet opening is typically smaller than the outlet of the housing to increase the velocity of the airflow as the airflow stream is forced through the nozzle outlet opening.

### SUMMARY

This section provides a general summary of the disclosure, and is not a comprehensive disclosure of its full scope or all of its features.

According to embodiments disclosed herein, a blower may include housing, a fan positioned within the housing, the fan having a fan edge. The blower may also include a fan housing section encircling the fan, the fan housing section having an inner surface that spans an inner circumference of the fan housing section, the inner surface having a plurality of indentations and being spaced within a certain distance from the fan edge.

According to embodiments disclosed herein, an axial blower may include a housing having a indented section, the indented section having a circular cross section and a plurality of indentations. The axial blower may also include a motor having a drive shaft housed in the housing and a fan attached to the drive shaft and being positioned in-line with the motor, the fan having a fan edge and being positioned within the indented section of the housing, a gap between the fan edge and the indented section being smaller than a certain size, the plurality of indentations increasing turbulence in airflow around the fan edge.

According to embodiments disclosed herein, a blower may include a housing having a fan section, the housing extending along a first direction and a motor housed in the housing, the motor having a drive shaft. The blower may also include a centrifugal fan attached to the drive shaft and being positioned to generate airflow in the first direction, the fan having a fan edge and being positioned within the fan section of the housing, the fan section having an inner surface that extends at least partially around the fan, in which a gap between the fan edge and the inner surface of portions of the fan section is within a certain gap size, and in which the inner surface of the fan section includes a plurality of curved indentations to create increased turbulence around the curved indentations as the motor rotates the fan.

### BRIEF DESCRIPTION OF THE DRAWINGS

Features of the present disclosure are illustrated by way of example and not limited in the following figure(s), in which like numerals indicate like elements, in which:

FIG. 1A shows a perspective view of a blower according to an embodiment of the present disclosure;

FIG. 1B shows a cross-sectional side view of the blower taken along lines A-A in FIG. 1A;

FIG. 2 shows a cross-sectional perspective view of a portion of the blower shown in FIGS. 1A and 1B;

FIG. 3 depicts an enlarged view of a portion of the housing section and the fan shown in FIGS. 1B and 2;

FIGS. 4 and 5, respectively, depict perspective views of housing sections having variously configured indentations according to embodiments of the present disclosure;

FIG. 6A shows a side view of a blower according to another embodiment of the present disclosure;

FIG. 6B shows a cross-sectional perspective of the blower depicted in FIG. 6A;

FIG. 6C shows a cross-sectional side view of the blower depicted in FIG. 6A; and

FIG. 6D shows a cross-sectional top view of a section of the blower taken along lines B-B in FIG. 6A.

### DETAILED DESCRIPTION

Blowers may include a fan (or equivalently, an impeller) that rotates within a housing to generate airflow from an upstream side of the fan to a downstream side of the fan. Reverse airflow (or backflow) may also be generated as the fan rotates, in which the reverse airflow is airflow that flows from the downstream side of the fan to the upstream side of the fan through a gap between the outer edge of the fan and an interior surface of the housing. The velocity of the airflow flowing in the downstream direction may be decreased by streams of airflow flowing in the upstream direction. Thus, for instance, by reducing the size of the gap between the outer edge of the fan and the interior surface of the housing, the generated airflow may be improved. However, designing the axial blowers such that the gaps between the fans and the housing sections to be relatively small, e.g., less than about 1.5 mm, may cause manufacturing tolerances to be maintained at a high level to prevent, for instance, contact between the outer edges of the fans and the housing sections. Moreover, maintaining the manufacturing tolerances at the high level may increase costs associated with fabricating the axial blowers.

Disclosed herein are blowers having indentations formed in fan housing sections around fans of the blowers that may effectively decrease the size of the gaps between the fans and the interior surfaces of the housings. That is, as air flows into and around the indentations, turbulent airflow may be generated within the indentations and the turbulent airflow may form an airflow barrier, which may effectively reduce the sizes of the gaps between the outer edges of the fans and the interior surfaces of the housings. In this regard, the blowers disclosed herein may be fabricated with relatively lower manufacturing tolerances while still achieving a high level of airflow velocity and flow characteristics.

In the blowers disclosed herein, the indentations may be formed around the entire interior surfaces of the fan housing sections that encircle the fans, for instance, to minimize backflow of air through the fan housing sections in the blowers. The indentations may additionally be provided in other areas of the blower, for instance, those areas of the blower that may experience or may be predicted to experience turbulent flow. In this regard, the indentations may improve the flow of air through the blower in addition to increasing the velocity at which air flows through the axial blower.

The indentations may have dimensions and may be spaced at certain distances with respect to each other to maximize the improvement in the airflow and/or the increase in airflow speed. In some examples, the indentations may have the same sizes and/or may be spaced apart at the same distances with respect to each other. In other examples, some of the indentations may have different sizes as compared with other indentations and/or may be spaced apart at different distances with respect to other indentations. In addition, or in other examples, the indentations may be arranged in a repeating pattern, a random pattern, in aligned configurations, or the like. The sizes and placements of the indentations in an blower may be determined through testing, simulations, etc.

Before continuing, it is noted that as used herein, the terms “includes” and “including” mean, but are not limited to, “includes” or “including” and “includes at least” or “including at least.” The term “based on” means, but is not limited to, “based on” and “based at least in part on.”

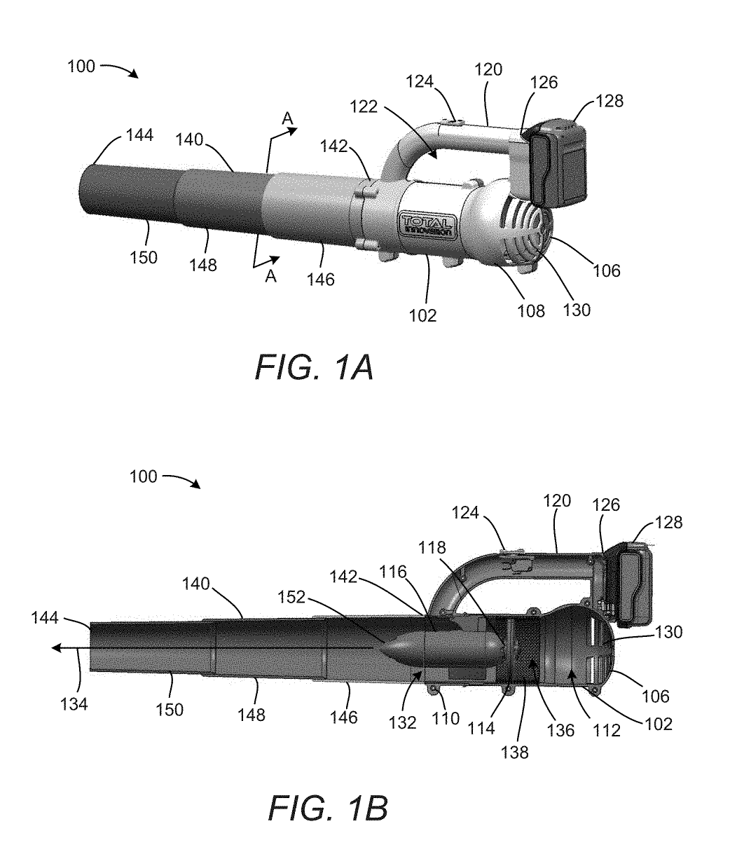

Reference is first made to FIGS. 1A and 1B. FIG. 1A shows a perspective view of a blower 100 according to an embodiment of the present disclosure. FIG. 1B shows a cross-sectional side view of the blower 100 taken along lines A-A in FIG. 1A. It should be understood that the blower 100, which is also referenced herein as an axial blower 100 or an apparatus 100, depicted in FIGS. 1A and 1B may include additional components and that some of the components described herein may be removed and/or modified without departing from a scope of the blower 100 disclosed herein.

As shown in FIGS. 1A and 1B, the blower 100 includes a housing 102 and a blower tube 140 attached to the housing 102. The housing 102 may be formed of a first part 106 and a second part 108, in which the second part 108 may have a configuration that is a mirror image of the first part 106. The first part 106 may be attached to the second part 108 via mechanical fasteners provided through aligned holes 110 formed on the first part 106 and the second part 108. Alternatively, the first part 106 may be attached to the second part 108 via adhesives, mating components, combinations thereof, or the like. The housing 102 may also be formed of plastic, metal, combinations thereof, or the like.

In any event, the first part 106 and the second part 108 may include concave shapes such that when the first part 106 is attached to the second part 108, a chamber 112 is formed in the interior of the housing 102. FIG. 1B depicts the blower 100 with the second part 108 removed such that an interior of the housing 102 may be visible. As shown in FIG. 1B, a fan 114 and a motor 116 are positioned within the chamber 112 formed in the housing 102. Particularly, the fan 114 is depicted as being attached to a drive shaft 118 of the motor 116 in an in-line arrangement with the motor 116. That is, the motor 116 is depicted as being positioned downstream of the airflow direction generated by the fan 114. In addition, the housing 102 is depicted as extending along a relatively straight line with the motor 116 and the fan 114. Alternatively, the motor 116 may be positioned upstream of the airflow direction generated by the fan 114. As the fan 114 and the motor 116 may be in-line with respect to each other in the direction of airflow, the blower 100 may be an axial blower.

The housing 102 may also include a handle 120 that an operator may grasp, for instance, to carry the blower 100 and to also control operation of the motor 116 and thus the fan 114. The handle 120 may be integrally formed with the housing 102 as shown in FIGS. 1A and 1B or may be mounted to the housing 102 via mechanical fasteners, adhesive, or the like. The handle 120 may extend at an angle with respect to the housing 102 such that a space 122 may be formed between the handle 120 and the housing 102. In addition, a switch 124 may be provided on the handle 120 at a location that may be convenient for an operator to actuate the switch 124 with an operator's finger.

As also shown in FIGS. 1A and 1B, the handle 120 may include a battery support section 126 to support a battery 128. The battery support section 126 may include a slot into which the battery 128 may be inserted and held in place with respect to the handle 120. The battery 128 may be fixedly attached to the battery support section 126 or may be removably attached to the battery support section 126. That is, in some examples, the battery 128 may be a removable battery while in other examples, the battery 128 may be integrated with the handle 120 and/or more generally, the housing 102. In addition, or in other examples, the battery 128 may be a rechargeable battery.

In operation, actuation of the switch 122 may control delivery of energy from the battery 128 to the motor 116. For instance, depression of the switch 124 may cause energy to be delivered to the motor 116 from the battery 128. In addition, delivery of energy to the motor 116 may cause the motor 116 to rotate, which may cause a drive shaft 118 of the motor 116 and the fan 114 to rotate. The fan 114 includes a plurality of blades such that as the fan 114 rotates, airflow is caused to be brought into the chamber 112 through inlet holes 130 of the housing 102. In addition, rotation of the fan 114 causes airflow to be forced out of the housing 102 through an outlet opening 132 of the housing 102, as represented by the arrow 134.

As also shown in FIG. 1B, the housing 102 may also include a fan housing section 136 encircling the fan 114, in which the fan housing section 136 includes a plurality of indentations 138, which are also referenced herein as curved indentations or dimples 138. The plurality of indentations 138 may span across an entire inner circumference of the fan housing section 136, which is also referenced herein as an indented section 136 or a fan section 136. As shown, the fan housing section 136 may include a portion of the housing 102 that is adjacent to the outer edge (also referenced herein as a fan edge) of the fan 114, e.g., adjacent to the outer edges of the fan 114 blades. In addition, the fan housing section 136 may extend across a width that is substantially greater than a width of the fan 114. For instance, the fan housing section 136 may extend at least 0.5 inch on either side of the fan 114. In other examples, the indentations 138 may be provided at a relatively larger interior surface area of the housing 102, e.g., throughout the interior surface of the housing 102. In particular examples, the indentations 138 may be provided at areas of the interior surface at which turbulent airflow occurs. Moreover, the fan housing section 136 may be located at a relatively short distance from the outer edge of the fan 114. As discussed in greater detail herein, the indentations 138 in the fan housing section 136 may increase turbulence of airflow around the outer edges of the fan 114 as compared with configurations in which the indentations 138 are omitted.

The blower 100 is also depicted as including a blower tube 140 attached to the outlet opening 132 of housing 102. The blower tube 140 may be attached to the housing 102 through a suitable attachment mechanism. For instance, the blower tube 140 may be attached to the housing 102 via mechanical fasteners, via an adhesive, via physical mating elements, e.g., tongue-and-groove elements, via friction fit, or the like. Alternatively, a segment 146 of the blower tube 140 may integrally be formed with the housing 102. In any regard, the blower tube 140 may have a tapered configuration in which a first end 142 of the blower tube 140 that is attached to the housing 102 has a larger diameter than a second end 144 of the blower tube 140 that is located distally from the first end 142. The blower tube 140 may also be formed of multiple converging segments 146-150 that may be arranged in a telescoping configuration with respect to each other. That is, a third segment 150 may be insertable into a second segment 148 and the second and third segments 148, 150 may be insertable into a first segment 146 to reduce a size of the blower tube 140. In other examples, however, the blower tube 140 may be formed of a single segment. According to examples, the blower tube 140 may have a length that may enable the second end 144 to be located near the ground when an operator holds the blower 100.

According to the embodiment shown in FIG. 1B, a cone 152 may be provided on the motor 116 downstream of the fan 114. The cone 152 may improve airflow through the blower tube 140, which may increase the velocity of airflow expelled through the blower tube 140, for instance, by reducing recirculation of airflow into the motor 116. In addition, or in other examples, at least a portion of the interior surface of the blower tube 140 may be provided with indentations 138. For instance, portions of or the entire interior surface of the blower tube 140 may be provided with indentations 138. Moreover, indentations 138 may also be provided on surfaces of the motor 116, the cone 152, the fan 114, as well as other surfaces in the interior of the blower 100 over which air may flow.

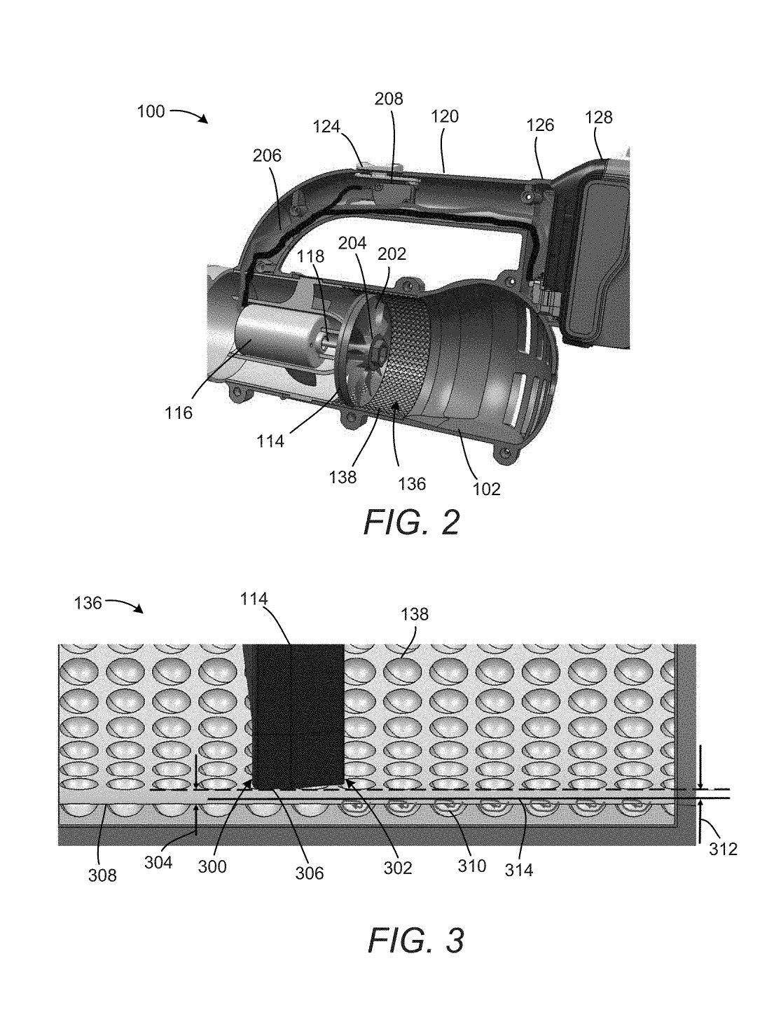

Turning now to FIG. 2, there is shown a cross-sectional perspective view of a portion of the blower 100 depicted in FIGS. 1A and 1B. As shown in FIG. 2, the fan 114 is depicted as including a plurality of blades 202 extending from a hub 204 that is attached to the drive shaft 118. In addition, wiring 206 is depicted as connecting the battery 128 with the motor 116 and an actuator 208 of the switch 124. Moreover, in the embodiment shown in FIG. 2, the cone 152 is not depicted as being positioned on the motor 116.

Reference is now made to FIG. 3, which depicts an enlarged view of a portion of the fan housing section 136 and the fan 114 shown in FIGS. 1B and 2. As shown in FIG. 3, the fan housing section 136 may include a plurality of indentations 138 arranged in a pattern across in inner area of the fan housing section 136. In operation, as the fan 114 rotates, air may flow from a downstream part 300 of the fan 114 back around to an upstream part 302 of the fan 114 through a gap 304 between an outer edge 306 of the fan 114 and the wall 308 of the fan housing section 136. The wall (inner surface) 308 of the fan housing section 136 may be within a certain distance of the outer edge 306 of the fan 114 around the periphery of the wall 308. For instance, the fan edge 306 is an extent to which the fan 114 extends from a center of the fan 114, in which the inner surface 308 of the fan housing section 136 extends about a center of the fan housing section 136, and in which the center of the fan 114 is collocated with the center of the fan housing section 136. By way of particular example, the distance between the outer edge 306 of the fan 114 and the wall 308 of the fan housing section 136 may be between about 0.5 mm and about 5 mm. In one embodiment, the distance between the fan 114 and the wall 308 of the fan housing section 136 is about 1.5 mm.

As represented by the arrows 310, the indentations 138 may cause turbulence of the airflow in the indentations 138 generated through rotation of the fan 114. The turbulence 310 may result in a gap 312 between the outer edge 306 of the fan 114 and an effective edge 314 formed by the turbulence 310 to be smaller than the gap 304 between the outer edge 306 of the fan 114 and the wall 308 of the fan housing section 136. The smaller gap 312 may reduce the amount of air flowing back from the downstream part 300 to the upstream part 302 of the fan 114. The reduction in the reverse flow of the air may result in an increase in efficiency in the generation of airflow by the fan 114. In addition, the increase in efficiency may result in an improvement in the airflow and/or increase In the airflow speed.

The inclusion of the indentations 138 may also enable manufacturing tolerances to be relatively higher while still providing the increased airflow. That is, through the indentations 138, the fan 114 and the wall 308 of the fan housing section 136 may be fabricated to have a relatively larger gap 304 while still providing the increased airflow, which may reduce manufacturing costs associated with the blower 100.

As shown in FIG. 3, the indentations 138 may not extend through the fan housing section 136, e.g., the indentations 138 may not include holes through which air may flow. Instead, the indentations 138 are depicted as each being formed of spherical indentations or curved depressions that are spaced from neighboring indentations 138 by certain distances. According to examples, the dimensions of the indentations 138 and the spacings of the indentations 138 with respect to each other may strategically be selected to improve airflow (e.g., less turbulent flow) and/or increase airflow speed. Thus, for instance, the dimensions and the spacings of the indentations 138 may be selected based upon the configuration and operation of the fan 114 and may vary for different 114 and motor 116 combinations. The dimensions of the indentations 138 may include the radius of curvatures, the depths, the widths, combinations thereof, or the like.

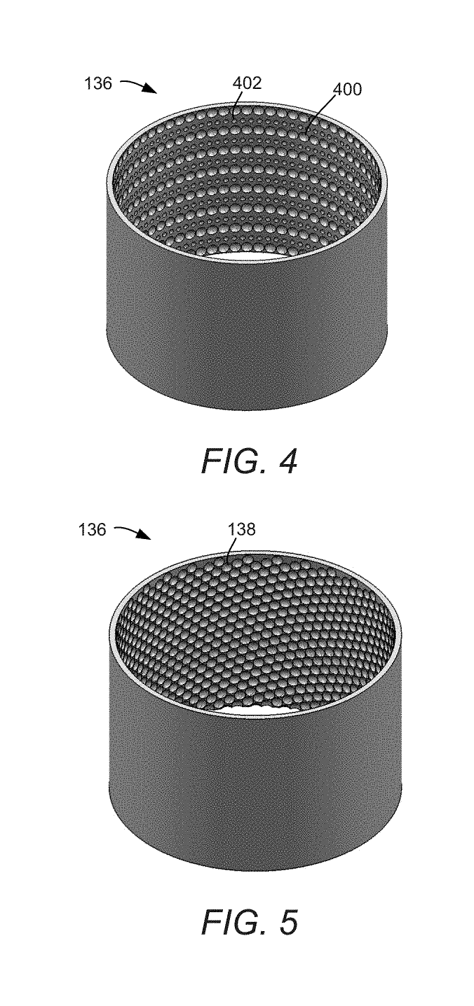

According to examples, each of the indentations 138 may have the same dimensions and may be spaced apart from neighboring indentations 138 by the same distances with respect to each other. By way of particular example, the indentations 138 may each have a radius of curvature of between around 1 mm and around 10 mm. In addition or in other examples, the indentations 138 may be spaced apart from each other by distances of between around 1 mm and around 10 mm. In other examples, some of the indentations 138 may have different sizes with respect to each other and/or some of the indentations 138 may be spaced apart from each other by different distances with respect to each other. An example of a fan housing section 136 having indentations 138 of different sizes with respect to each other is shown in FIG. 4. Particularly, FIG. 4 shows a perspective view of a fan housing section 136 having indentations 400 having a first size and indentations 402 having a second size.

As also shown in FIG. 3, the indentations 138 may be arranged in aligned columns and rows across the inner area of the fan housing section 136. In other examples, the indentations 138 may be arranged in other patterns, e.g., in random locations, in a regular repeating pattern, in an irregular repeating pattern, combinations thereof, or the like. An example of a fan housing section 136 having indentations 138 arranged in a different pattern from that shown in FIG. 3 is shown in FIG. 5. Particularly, FIG. 5 shows a perspective view of a fan housing section 136 having indentations 138 that are arranged in a helical configuration with respect to each other.

According to examples, the fan housing section 136 is formed in areas of the first part 106 and the second part 108 of the housing 102. In these examples, the indentations 138 may be formed into the interior surfaces of areas of the first part 106 and the second part 108 of the housing 102. Thus, for instance, the indentations 138 may be formed into the first part 106 and the second part 108 during fabrication of the first part 106 and the second part 108, for instance, through molding. In other examples, the fan housing section 136 is formed as an insert that is separate from the housing 102. In these examples, the fan housing section 136 may be formed as a cylindrical collar that may be inserted in an interior area formed through attachment of the first part 106 to the second part 108 of the housing 102. In addition, the fan housing section 136 may be formed of plastic, metal, ceramic, an alloy, combinations thereof, or the like through any suitable fabrication technique.

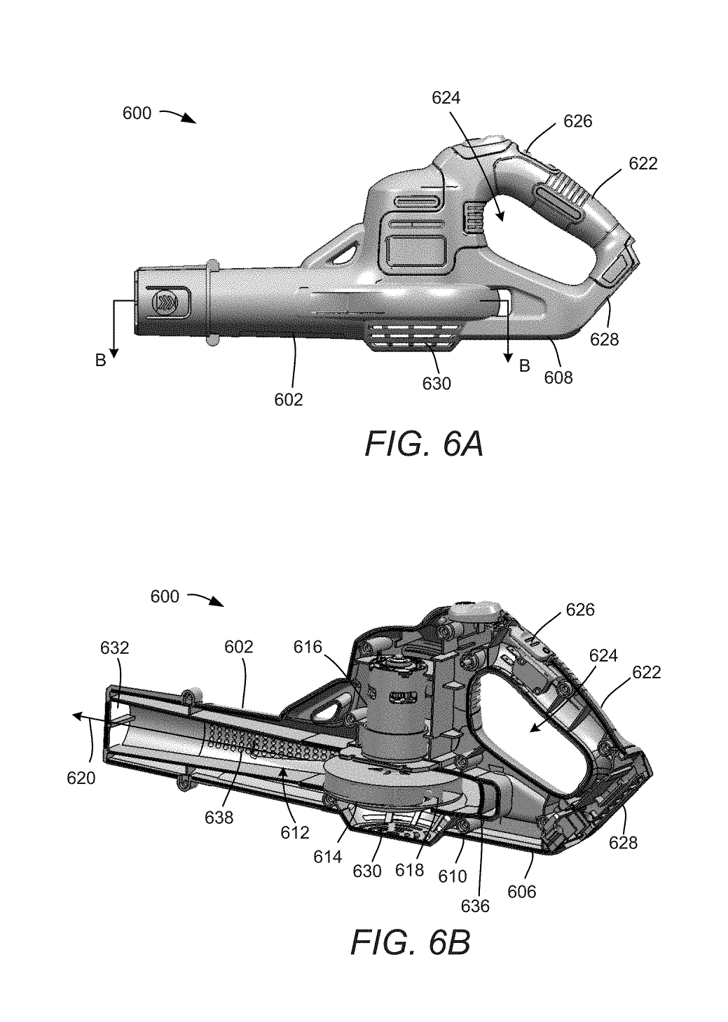

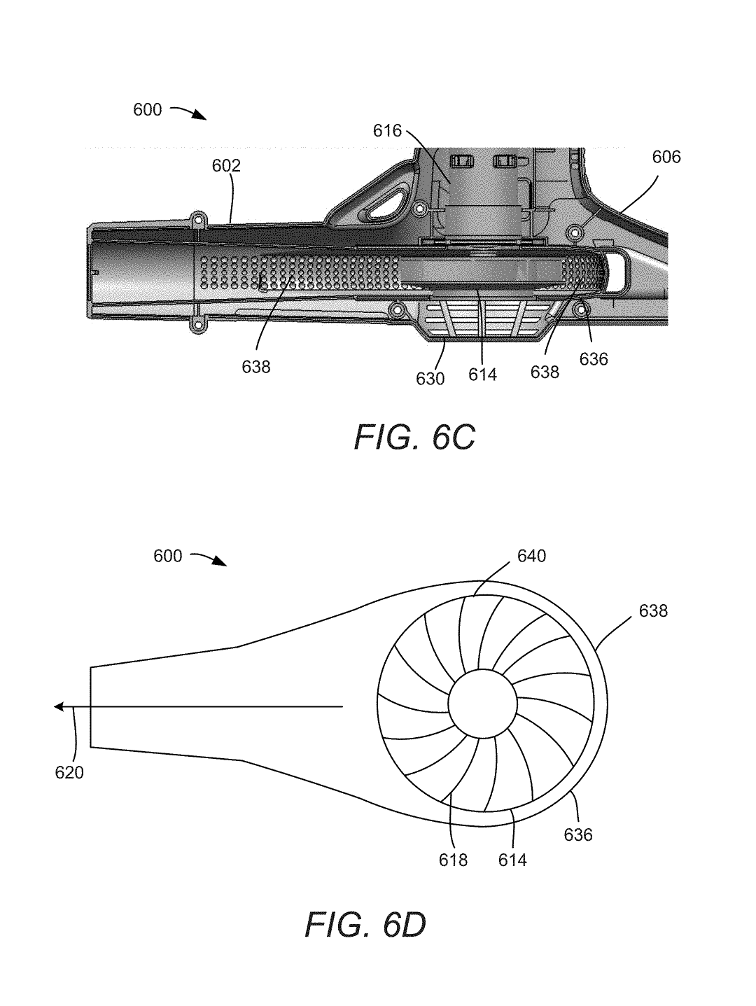

Reference is now made to FIGS. 6A-6D, which respectively show diagrams of a blower 600 according to another embodiment of the present disclosure. Particularly, FIG. 6A shows a side view of the blower 600, FIG. 6B shows a cross-sectional perspective view of the blower 600, FIG. 6C shows a cross-sectional side view of a section of the blower 600, and FIG. 6D shows a cross-sectional top view of the blower 600 taken along lines B-B in FIG. 6A. It should be understood that the blower 600, which is also referenced herein as a centrifugal blower 600 or an apparatus 600, depicted in FIGS. 6A-6D may include additional components and that some of the components described herein may be removed and/or modified without departing from a scope of the blower 600 disclosed herein.

As shown in FIGS. 6A-6D, the blower 600 includes a housing 602 that may be formed of a first part 606 and a second part 608, in which the second part 608 may have a configuration that is a mirror image of the first part 606. The first part 606 may be attached to the second part 608 via mechanical fasteners provided through aligned holes 610 formed on the first part 606 and the second part 608. Alternatively, the first part 606 may be attached to the second part 608 via adhesives, mating components, combinations thereof, or the like. The housing 602 may also be formed of plastic, metal, combinations thereof, or the like.

In any event, the first part 606 and the second part 608 may include concave shapes such that when the first part 606 is attached to the second part 608, a chamber 612 is formed in the interior of the housing 602. FIGS. 6B and 6C depict the blower 600 with the second part 608 removed such that an interior of the housing 602 may be visible. As shown in FIGS. 6B and 6C, a fan 614 and a motor 616 are positioned within the chamber 612 formed in the housing 602. Particularly, the fan 614 may be attached to a drive shaft (not shown) of the motor 616. In addition, the motor 616 is depicted as being positioned at an angle, e.g., perpendicularly, with respect to the direction in which the fan 614 generates airflow. That is, the fan 614 includes blades 618 that are to generate airflow in the direction denoted by the arrow 620. As the motor 616 may not be located in the in line with the fan 614 in the direction of airflow 620, the blower 600 may be a centrifugal blower.

The housing 602 may also include a handle 622 that an operator may grasp, for instance, to carry the blower 600 and to also control operation of the motor 616 and thus the fan 614. The handle 622 may be integrally formed with the housing 602 as shown in FIGS. 6A and 6B or may be mounted to the housing 602 via mechanical fasteners, adhesive, or the like. The handle 622 may extend at an angle with respect to the housing 602 such that a space 624 may be formed between the handle 622 and the housing 602. In addition, a switch 626 may be provided on the handle 620 at a location that may be convenient for an operator to actuate the switch 626 with an operator's finger.

As also shown in FIGS. 6A and 6B, the handle 622 may include a battery support section 628 to support a battery (not shown). The battery support section 628 may include a slot into which a battery may be inserted and held in place with respect to the handle 622. The battery may be fixedly attached to the battery support section 628 or may be removably attached to the battery support section 628. That is, in some examples, the battery may be a removable battery while in other examples, the battery may be integrated with the handle 620 and/or more generally, the housing 602. In addition, or in other examples, the battery may be a rechargeable battery.

In operation, actuation of the switch 626 may control delivery of energy from the battery to the motor 616. For instance, depression of the switch 626 may cause energy to be delivered to the motor 616 from the battery. In addition, delivery of energy to the motor 616 may cause the motor 616 to rotate, which may cause a drive shaft of the motor 616 and the fan 614 to rotate. The fan 614 includes a plurality of blades 618 such that as the fan 614 rotates, airflow is caused to be brought into the chamber 612 through inlet holes 630 of the housing 602. In addition, rotation of the fan 614 causes airflow to be forced out of the housing 602 through an outlet opening 632 of the housing 602.

As also shown in FIGS. 6B-6D, the housing 602 may also include a fan housing section 636 at least partially encircling the fan 614, in which the fan housing section 636 includes a plurality of indentations 638, which are also referenced herein as curved indentations or dimples 638. The plurality of indentations 638 may span across an entire inner surface of the fan housing section 636, which is also referenced herein as an indented section 636 or a fan section 636. In other examples, the indentations 638 may extend for a portion of the fan housing section 636, e.g., in the portions of the fan housing section 636 that are immediately adjacent to the fan 614. By way of particular example, the distance between the outer edge 640 of the fan 614 and portions of a wall of the fan housing section 636 may be between about 0.5 mm and about 5 mm. In one embodiment, the distance between the outer edge 640 of the fan 614 and a wall of the fan housing section 636 is about 1.5 mm.

As shown, the fan housing section 636 may include a portion of the housing 602 that is adjacent to an outer edge 640 (also referenced herein as a fan edge) of the fan 614, e.g., adjacent to the outer edges 640 of the fan 614 blades 618. In addition, the fan housing section 636 may extend across a height that is substantially greater than a height of the fan 614. For instance, the fan housing section 636 may extend at least 0.5 inch above and below the fan 614.

In other examples, the indentations 638 may be provided at a relatively larger interior surface area of the housing 602, e.g., throughout the interior surface of the housing 602 over which air is to flow. In particular examples, the indentations 638 may be provided at areas of the interior surface at which turbulent airflow occurs. Moreover, portions of the fan housing section 636 may be located at a relatively short distance from the outer edge of the fan 614 as shown in FIG. 6D. As discussed in greater detail herein, the indentations 638 in the fan housing section 636 may increase turbulence of airflow around the outer edges 640 of the fan 614 as compared with configurations in which the indentations 638 are omitted.

The indentations 638 may be similar to the indentations 138 discussed above with respect to FIGS. 1A-5. In this regard, for instance, the indentations 638 may each have a radius of curvature of between around 1 mm and around 10 mm. In addition or in other examples, the indentations 638 may be spaced apart from each other by distances of between around 1 mm and around 10 mm. In other examples, some of the indentations 638 may have different sizes with respect to each other and/or some of the indentations 638 may be spaced apart from each other by different distances with respect to each other, for instance, as shown in FIG. 4. Additionally, the indentations 638 may be formed in an interior surface of the housing 602 or in an insert that may be inserted into the housing 602.

Although not shown, the blower 600 may also include a blower tube attached to the outlet opening 632 of housing 602. The blower tube may be similar to the blower tube 140 shown in FIGS. 1A and 1B and may be attached to the housing 602 in any of the manners discussed above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A blower comprising:
a housing;
a fan positioned within the housing, the fan having a fan edge; and
a fan housing section encircling the fan, the fan housing section having an inner surface that spans an inner circumference of the fan housing section, the inner surface having a plurality of indentations and being spaced within a certain distance from the fan edge.

2. The blower of claim 1, wherein the blower is an axial blower comprising:
a motor in-line with the fan along a lateral dimension of the housing.

3. The blower of claim 1, wherein the fan edge is an extent to which the fan extends from a center of the fan, wherein the inner surface of the fan housing section extends about a center of the fan housing section, and wherein the center of the fan is collocated with the center of the fan housing section.

4. The blower of claim 1, wherein the certain distance between the inner surface of the fan housing section and the fan edge is less than about 5 mm and is greater than about 0.5 mm.

5. The blower of claim 1, wherein the fan has a first width and the fan housing section has a second width and wherein the second width is larger than the first width and wherein the plurality of indentations extend around a circumference and a width of the inner surface of the fan housing section.

6. The blower of claim 1, wherein the fan housing section comprises an insert that is separate from the housing, the insert being insertable at a section of the housing encircling the fan.

7. The blower of claim 1, wherein the fan housing section comprises a section of an interior surface of the housing encircling the fan.

8. The blower of claim 1, wherein the plurality of indentations have at least one of common shapes and sizes with respect to each other or one of different sizes with respect to each other.

9. The blower of claim 1, wherein the plurality of indentations are curved depressions in the inner surface of the housing section and the curved depressions have radius of curvatures of between around 1 mm and around 10 mm.

10. An axial blower comprising:
a housing having a indented section, the indented section having a circular cross section and a plurality of indentations;
a motor having a drive shaft housed in the housing; and
a fan attached to the drive shaft and being positioned in-line with the motor, the fan having a fan edge and being positioned within the indented section of the housing, a gap between the fan edge and the indented section being smaller than a certain size, the plurality of indentations increasing turbulence in airflow around the fan edge.

11. The axial blower of claim 10, wherein the fan edge is an extent to which the fan extends from a center of the fan, wherein the inner surface of the indented section extends from a center of the indented section, and wherein the center of the fan coincides with the center of the indented section.

12. The axial blower of claim 10, wherein the plurality of indentations extend around a circumference and a width of the indented section.

13. The axial blower of claim 10, wherein the indented section comprises an insert that is separate from the housing, the insert being insertable at a section of the housing that encircles the fan.

14. The axial blower of claim 10, wherein the indented section comprises a section of an interior surface of the housing that encircles the fan.

15. The axial blower of claim 10, wherein the plurality of indentations are sized and arranged on the indented section to enhance at least one of a speed and a volume at which air flows out of the axial blower.

16. A blower comprising:
a housing having a fan section, the housing extending along a first direction;
a motor housed in the housing, the motor having a drive shaft; and
a centrifugal fan attached to the drive shaft and being positioned to generate airflow in the first direction, the fan having a fan edge and being positioned within the fan section of the housing, the fan section having an inner surface that extends at least partially around the fan, wherein a gap between the fan edge and the inner surface of portions of the fan section is within a certain gap size, and wherein the inner surface of the fan section includes a plurality of curved indentations to create increased turbulence around the curved indentations as the motor rotates the fan.

17. The blower of claim 16, wherein the fan edge is an extent to which the fan extends from a center of the fan, wherein the inner surface of the fan section extends from a center of the fan section, and wherein the center of the fan coincides with the center of the fan section.

18. The blower of claim 16, wherein the fan section comprises an insert that is separate from the housing, the insert being insertable at a section of the housing that at least partially encircles the fan.

19. The blower of claim 16, wherein the fan section comprises a section of an interior surface of the housing that at least partially encircles the fan.

20. The blower of claim 16, wherein each of the plurality of curved indentations have radius of curvatures of between around 1 mm and around 10 mm.
